(19) United States
(12) Patent Application Publication
(10) Pub. No.: US 2013/0147604 A1
(43) Pub. Date: Jun. 13, 2013

(54) METHOD AND SYSTEM FOR ENABLING SMART BUILDING EVACUATION

(71) Applicants: Donald R. Jones, JR., New Canton, VA (US); Ronald Dubois, Dumfries, VA (US); David E. Kimmel, Fredricksburg, VA (US); Thomas G. Hahn, III, Williamstown, NJ (US); Kenneth Raymond Curley, Clifton Park, NY (US)

(72) Inventors: Donald R. Jones, JR., New Canton, VA (US); Ronald Dubois, Dumfries, VA (US); David E. Kimmel, Fredricksburg, VA (US); Thomas G. Hahn, III, Williamstown, NJ (US); Kenneth Raymond Curley, Clifton Park, NY (US)

(21) Appl. No.: 13/313,512

(22) Filed: Dec. 7, 2011

(51) Int. Cl. G08B 5/22

(52) U.S. Cl. 340/6.1

(57) ABSTRACT

The present invention is directed to providing a method and system that enables a first responder firefighter to take command of a building having a potential fire event. Using the method and system herein, the firefighter is able to clearly signal and guide the safe evacuation of that building. A group of sensors are mounted throughout the building to monitor various possible fire/smoke events. Also mounted in the building are signal arrays that are controlled and triggered by the firefighter to clearly delineate a safe and efficient evacuation route from the building.

The present invention relates generally to the efficient and safe monitoring and management of a building in the event of a fire emergency. More particularly, the present invention is directed to a method and system that enables a first responder firefighter to take command of a building having a potential fire event in order to clearly signal and guide the safe evacuation of that building, if necessary. A group of signal arrays are controlled and triggered by the firefighter to clearly delineate a safe and efficient evacuation route from the building prior to and/or after the arrival of the responding firefighters. This decision making is based on a remote view of the developing fire that shows fire location and spread.

### BACKGROUND

In the most common example, persons who live or work in a building and who are caught in a fire event are typically merely warned about a potential fire event, and preexisting exit routes are illuminated regardless of their proximity to the fire event. These conventional systems may employ a simple on/off siren or alarm in conjunction with the illuminated exit signs.

In some more sophisticated systems, persons in a building who are caught in a fire incident are directed to evacuate the building via an automated voice evacuation system that initializes when a fire alarm control panel goes into an alarm state. Unless the persons view the fire themselves, those persons do not have any direct knowledge whether there even is a fire or, if there is, where the fire is located. Except for not being able to use the elevator in a fire emergency, the only additional information conveyed to persons in the building is to evacuate using the nearest stairwell.

### SUMMARY

The present invention is directed to providing systems and methods for remotely monitoring sites to provide real-time information that can readily distinguish false alarms from real ones and that can identify and track the location of an alarm and/or its cause with substantial precision. In exemplary embodiments, fire detection capabilities can be implemented through the use of multistate indicators in a novel interface that permits information to be transmitted using standard network protocols from a remote site to a monitoring station in real-time over preexisting communication network transmission pathways (e.g. wire, fiber optic, wireless and satellite). Communications can thereby be established between a centrally located host monitoring station and a separate fire panel deployed in each of the buildings to be remotely monitored. Using this fire detection information, a first responder firefighter is able to identify a need, or not, for evacuation, and also to identify a safe evacuation route. Using the same communication network transmission pathway or pathways, the firefighter can activate visual displays in the building and signaling station in each room or flat to communicate safe evacuation routes to people in the building.

Embodiments of a system in accordance with the present invention may further comprise a graphical user interface. The information received from the sensor comprises a self-initiated notification signal indicating a change of the value of a parameter measured by at least one of the plurality of sensors. The information may be received at substantially the same time the change is measured. In some embodiments, temperature is displayed as an icon, and the color of the icon may indicate the value of the temperature and/or the state of a corresponding temperature sensor. Another embodiment of the present invention provides a system for monitoring a space having a plurality of sensors. Each of the plurality of sensors is located at a predetermined monitoring location. A monitoring system is configured to receive a substantially real-time self-initiated notification signal indicating a change of a value of a parameter measured by at least one of the plurality of sensors. Based on the notification signal, a graphic interface is configured to display the value of the parameter measured by the at least one of the plurality of sensors.

The term “fire panel,” as used in this specification, includes a wide variety of fire panels that are in communication with sensors, and that are capable of providing information to a monitoring system. “Fire panels” may include, but are not limited to, panels for monitoring fire or temperature information, the presence of chemicals or other contaminants in the air, acidity, alkalinity, water pressure, air pressure, wind velocity, magnitude of force, signal integrity, bit error rate, voltage, current, resistance, location of various physical objects, motion, vibration, sound, light, magnetic field, and any other parameters (or changes in parameters) that are measurable by sensors or capable of being determined or identified by processors that process sensor information.

In exemplary embodiments, communications can be transmitted from a centrally located host monitoring system to a mobile monitoring station (for example, to a laptop computer in a responding vehicle, such as a fire vehicle). The transmission can be such that direct communications are established between a fire panel located at a site being monitored and the mobile monitoring station (for example, via communication with a laptop over a wireless network). Alternatively or in addition, indirect communications can be established via the host monitoring station.

The term “parameter” is meant broadly to encompass a wide range of parameters that can be measured by a sensor. Parameters include, but are not limited to, temperature, concentration of various chemicals (such as combustible gases) in the air or elsewhere, water pressure, wind velocity, magnitude of force, a measure of signal integrity or bit error rates in communications transmissions facilities such as fiber-optic cables, geometric position of various mechanical devices such as valves and any other parameter, such as those parameters mentioned herein, that may be measured such that a state or change in state of the parameter may be determined. The term “parameter” may also include, as a further example, the state of a signal that displays a safe evacuation route.

Embodiments of the present invention can provide primary visual alarm status reporting that gives the monitoring authority (e.g., a user) the ability to identify the precise location of a fire, and to distinguish false alarms from real ones. Multiple state, or multistate, indications are provided to represent a sensor. For example, in various embodiments, each sensor may be identified as being: (1) currently in alarm; (2) currently in alarm and acknowledged by a monitor; (3) recently in alarm; (4) not in alarm; (5) disabled; or (6) non-reporting. With these multistate indications, the movements of a fire can be tracked, and yet the location of the fire can still be identified with a great deal of precision. This additional tracking ability gives firemen a tactical advantage at the scene as they know the location of the fire and can track any subsequent movements as they close in order to fight the fire.

Exemplary embodiments of the present invention are directed to a method and apparatus for monitoring a space. A fire panel is associated with a plurality of sensors. A monitoring system receives real-time or substantially real-time information regarding the space from the fire panel over a network using a network protocol. The monitoring system includes a graphic interface to display said information as multistate outputs associated with each of the plurality of sensors. Also, the fire panel is often referenced in this application as being located at the space or building. While the physical location of a physical panel can be within the confines of the space or building, the fire panel may also exist remotely in terms of data and information in off-site servers. These off-site servers may also receive and process and present the on-site sensor information and display parameters.

### BRIEF DESCRIPTION OF THE DRAWINGS

FIG. 1 shows an exemplary graphics screen viewed through a fire panel screen, wherein the graphics display contains a floor plan layout, with special icons overlaid on a map to identify sensor points and their status and signal array options and their status.

FIGS. 2 and 3 show exemplary graphics screens as described in FIG. 1 except that there are various sensors and signal array icons that are activated in a hypothetical example of a fire event.

FIG. 4 shows a general overview of communications transpired between four basic subsystems.

FIG. 5 shows a detailed diagram of an exemplary host computer in a supervisory monitoring system.

FIG. 6 shows a detailed diagram of an exemplary remote computer.

FIG. 7 shows a detailed diagram of an exemplary fire panel.

FIG. 8 shows a detailed diagram of an exemplary mobile computer.

FIG. 9 shows an exemplary graphics screen viewed through a fire panel screen, wherein the graphics display contains a floor plan layout, with special icons overlaid on a map to identify sensor points, signaling stations and their status and signal array options and their status.

FIG. 10 shows an exemplary graphics screen viewed through a fire panel screen, wherein the graphics display contains a floor plan layout, with special icons overlaid on a map to identify activated sensor points, activated signaling stations and their status and signal array options and their status.

### DETAILED DESCRIPTION

The current method and apparatus maybe implemented together with or partially with the method and apparatus disclosed in earlier U.S. Pat. No. 6,917,288, “Method and Apparatus for Remotely Monitoring A Site”, issued Jul. 15, 2005, which is incorporated herein by reference in its entirety.

The present method and system provide the tools for a first responder, in this case a firefighter, to monitor and manage the safe evacuation of a building that is subject to a possible fire event. The discussion that follows often references a single building that is being monitored and that is able to be managed by a first responder. The method and system is able to be deployed in two or more buildings equally efficiently.

In each building, a plurality of signal arrays are installed. The signal arrays are adapted to each be able to display a plurality of different signals—in one example, a green, yellow or red signal. A plurality of fire alarm sensors are also installed in the building. A fire alarm panel is operatively linked to the arrays and to the sensors and it is further linked to a first responder firefighter computer. When a sensor is activated, an alarm is sent to a firefighter or emergency response center (ERC). The first responder firefighter or ERC is then able to call up a building floor plan on a computer wherein the building is the site of the possible fire event. The firefighter or ERC is able to identify an appropriate evacuation route for any persons who may be in the building. The firefighter or ERC then instructs the display of signals on the arrays inside the building to visually guide persons in the building to evacuate the building safely. Specifically, the signal arrays are installed and are visually accessible in the building and proximate exit doors and paths within the building. In addition signaling stations installed in each flat and visually accessible to the individual residents display current status information and evacuation instructions. The firefighter who monitors the fire event, whether a mobile first responder or a supervisor at the ERC, can judge the best route for the efficient exit of persons in the building. Those persons may be guided in a direction away from the fire event. They may also be guided in the direction away from the projected access path of the firefighters and other first responders.

In one example, actions are initiated when a sensor detects a change in one or more relevant parameters such as heat or smoke. When this happens, the signal arrays turn on a color such as yellow LED. Simultaneously this information is displayed and/or announced on individual signaling stations located in each room or flat. This means there is a possible fire emergency, remain on the floor unless the signals turn to red or green and then evacuate to the stairwells lit by color green.

Simultaneously, graphic annunciators located near a lobby on each floor will display a floor graphic showing the nearest stairwells and their current standby status. This provides the occupants with information that a building emergency is in affect, and they may or may not be able to use the stairwell nearest to them for evacuation. A firefighter first responder viewing the evolving situation in the building on a mobile computer conducts his size-up and instructs his engine companies which building stairwells to use as they advance to the fire-floor. This real-time information lets him know what stairwells to use for evacuation and what floors he wants to evacuate. The fire fighter may relay this information via tactical radio communication to an operator at the local fire department viewing the evolving situation of a different computer being fed the same information.

All monitoring stations viewing the evolving situation have icons which display an evacuation control application. These icons can activate and control building evacuation signal stations. However, some monitoring stations can only view signal array status information to minimize the chance of someone selecting the wrong icon.

The designated operator at a designated monitoring station or ERC viewing the evolving situation can activate this application by clicking on the icon, which will display a screen that has a graphic of the building outline showing the stairwells locations; and on either side of the stairwell two triangular symbols, one color green and one color red. The building diagram is labeled A for street side and then clockwise B, C and D. So stairwells are correspondingly labeled AB, CB, CD and AD. If there is one in the center of the building is would be labeled center (CC).

Based on a firefighter's instruction delivered over the tactical radio network to an operator at the designated station, the operator will touch the appropriate output icon color Green or color Red. This command will activate the corresponding icons, going from the light color to a bright color indicating that the stairwell can be used in the case of color Green or not be used in the case of color Red.

Prior to the control panel executing these evacuation instructions, the operator will designate which floors to be evacuated. These instructions can include the evacuation of all or individual floors, decisions made by the on-site fire commander. After inputting and reviewing these instructions, the operator will initiate the command which will automatically instruct the control panel to activate each stairwell's signaling array. Designated evacuation stairwells will display the color Green while stairwells not designated for evacuation will display color Red. Any floors not selected will remain in the color Yellow conditions on the signal array. Signaling stations also indicate the change in status by providing both visual and audio evacuation instructions.

The colors yellow, green and red are discussed as an example only. Other colors may be used, and other visual displays may be used. Also, blinking or flashing signs may be used. The key is to communicate different actions to persons in the building.

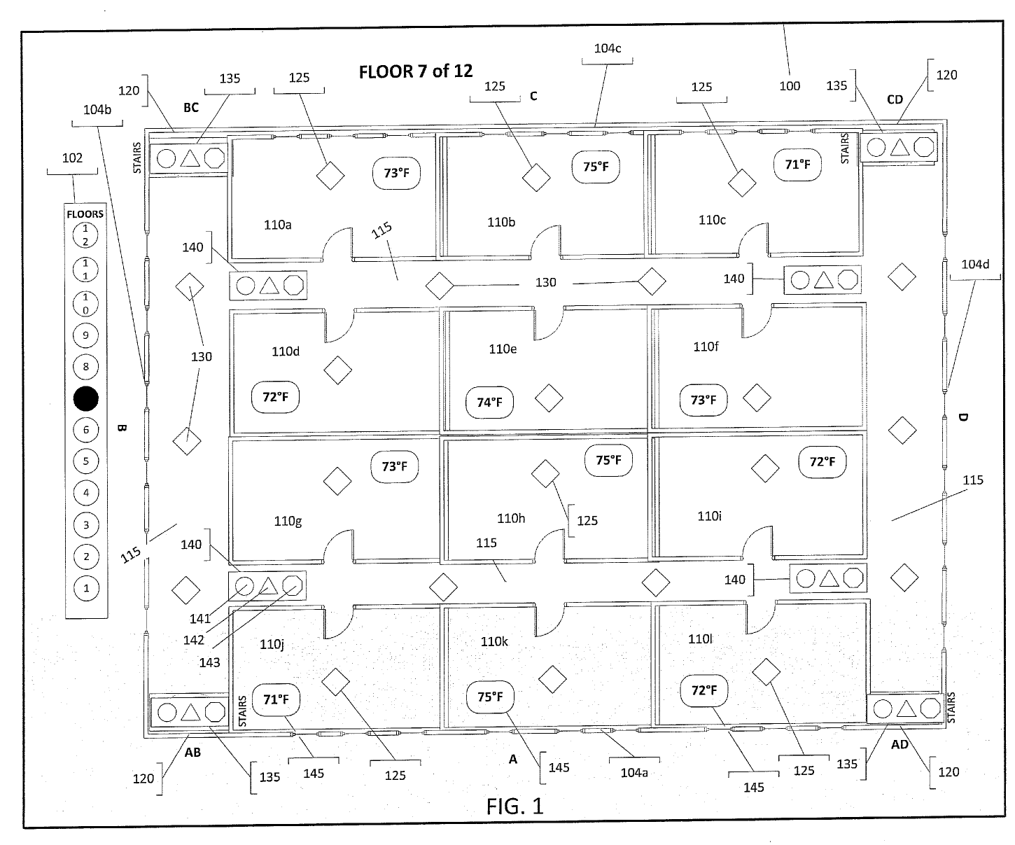

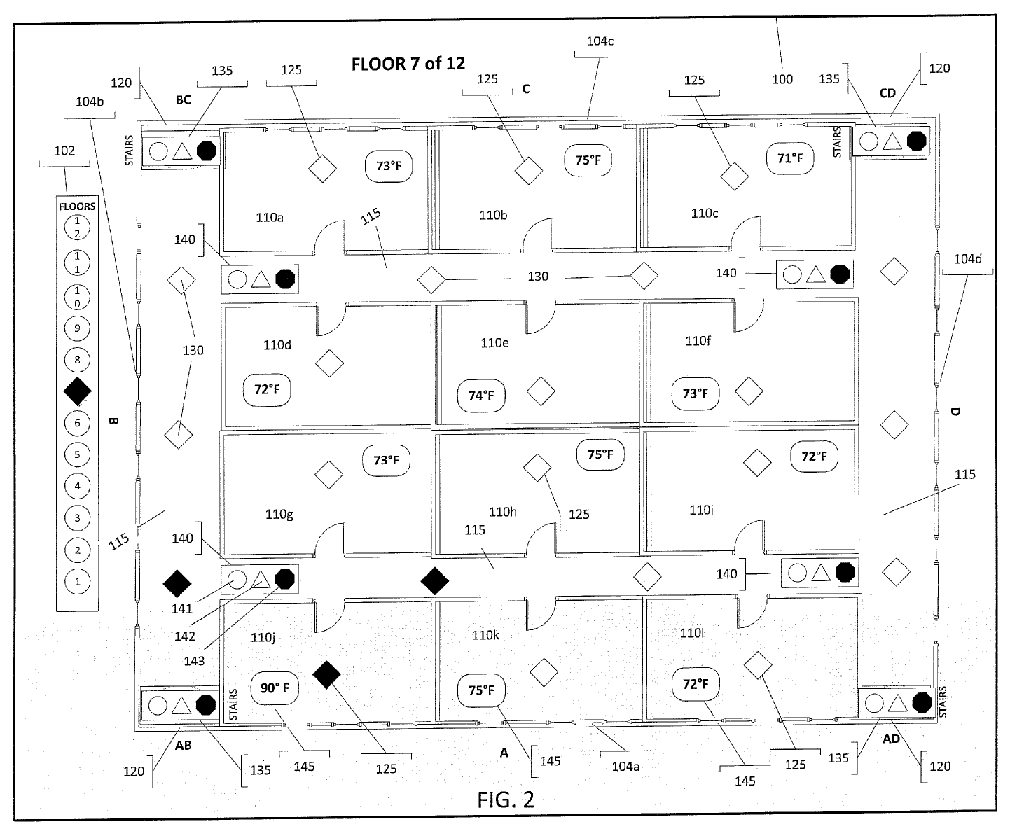

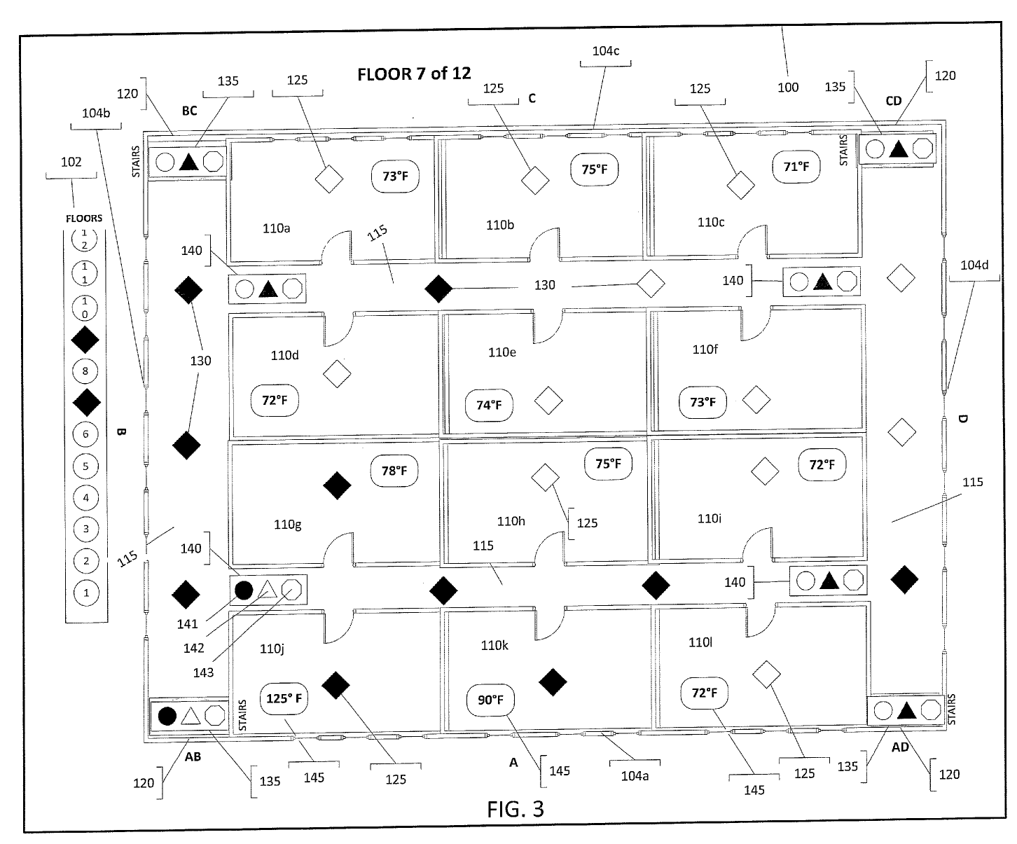

The present system and method are demonstrated in FIGS. 1-3 that show a hypothetical building in a normal monitoring state (FIG. 1), an alarm state (FIG. 2), and (FIG. 3) a safe evacuation state.

FIG. 1 shows a graphics screen containing a floor plan 100 for a building. The hypothetical building has twelve floors as shown in the Table 102. The Table 102 has activated the circle with the “7” in it to indicate that this floor plan 100 denotes the 7^{th} floor of the twelve floor building. Floor plan 100 includes a rectangular building having four sides 104a-104d. Each of these sides 104a-104d has an indicator A, B, C and D to differentiate the sides of the building floor plan 100.

There are twelve rooms 110 (numbered 110a-1) that are shown in this floor plan 100. Hallways 115 are located in between the rooms 110 and along each end 104b and 104d of the building. Four stairways 120 are shown in each corner of the building floor plan 100.

Inside each room 110 there is a fire sensor 125. As described earlier herein, this sensor may detect heat, smoke, or any one or more of numerous additional parameters. Alternatively, the sensor 125 may also be manually activated by a person in a room 110. The hallways 115 also have sensors 130 mounted therein to detect various fire parameters similar to the room sensors 125.

Positioned proximate each stairway 120 is a signal array 135. Each signal array 135 is shown as having three icons 141, 142 and 143 displayed thereon. The icons 141, 142 and 143 are shown separately in this floor plan 100. The actual signal array 135 may contain the multiple icons 141, 142 and 143 or, alternatively, may constitute a single display that may have the functionality to visually display different icons on a single screen. There are also hallway signal arrays 140 that are positioned along the hallways of the floor plan 100. These signal arrays 140 also contain the similar icons 141, 142 and 143. It is envisioned that the hallway arrays 140 may also display directional instructions such as arrows to guide a path when in use.

Finally, there is a temperature display 145 in each room 110 that sets forth the actual temperature in each room 110. This display 145 may also be able to display other information. The temperature display is one example of the type of information that could be displayed in each room 110.

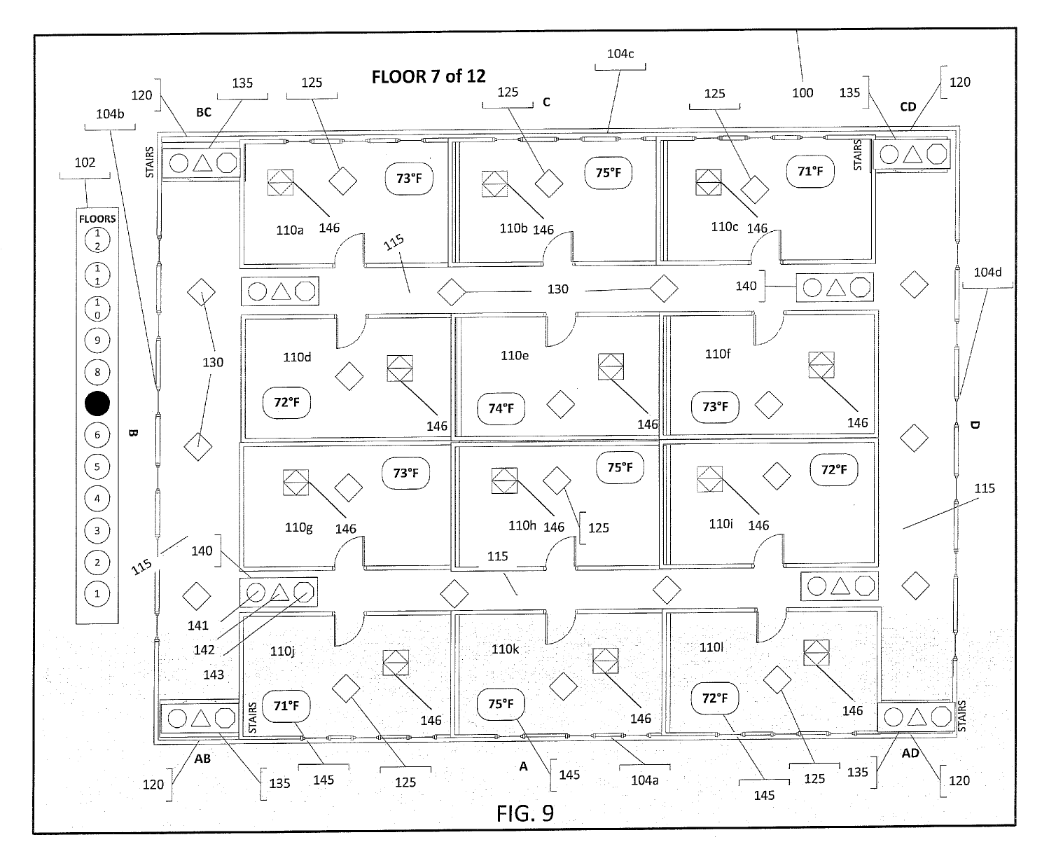

FIG. 1 shows all of the sensors and all of the signal arrays in the open and inactive state with the temperature icon in each room displaying a normal current room temperature. The only icon that is activated is the floor 7 indicator in the table 102 that simply reinforces that this particular graphic illustrates floor 7 of 12. FIG. 9 is similar to FIG. 1 but contains additional icons representing individual room signaling stations 146 in the open and inactive state.

Turning now to FIG. 2, the floor plan 100 of FIG. 2 is essentially identical to the floor plan graphics of FIG. 1 except that an exemplary fire detection event is illustrated. Specifically, as shown in FIG. 2, the floor designator in the table 102 is shown having an activated alarm symbol at floor 7. The image in FIG. 2 also shows that the sensors 125 in the AB corner of the building 100 have been activated as detecting a change in parameter. This change is corroborated by the temperature display 145 in room 110; that indicates that the temperature in the room has increased to 90° F. The signal arrays 135 and 140 are triggered and show an activated icon 143 that is yellow. As explained earlier, this activated icon 143 means that there is a possible fire emergency. This icon may instruct the persons on the floor to remain on that floor unless and until the signal arrays change color or provide other instructions. Accordingly, FIG. 2 is a hypothetical example of the state of the sensors 125 and the location of the sensors 125 on the floor 100. FIG. 2 also shows the state of the signal arrays 135 and 140 and the messages that they are currently transmitting to persons on floor 7 of the building.

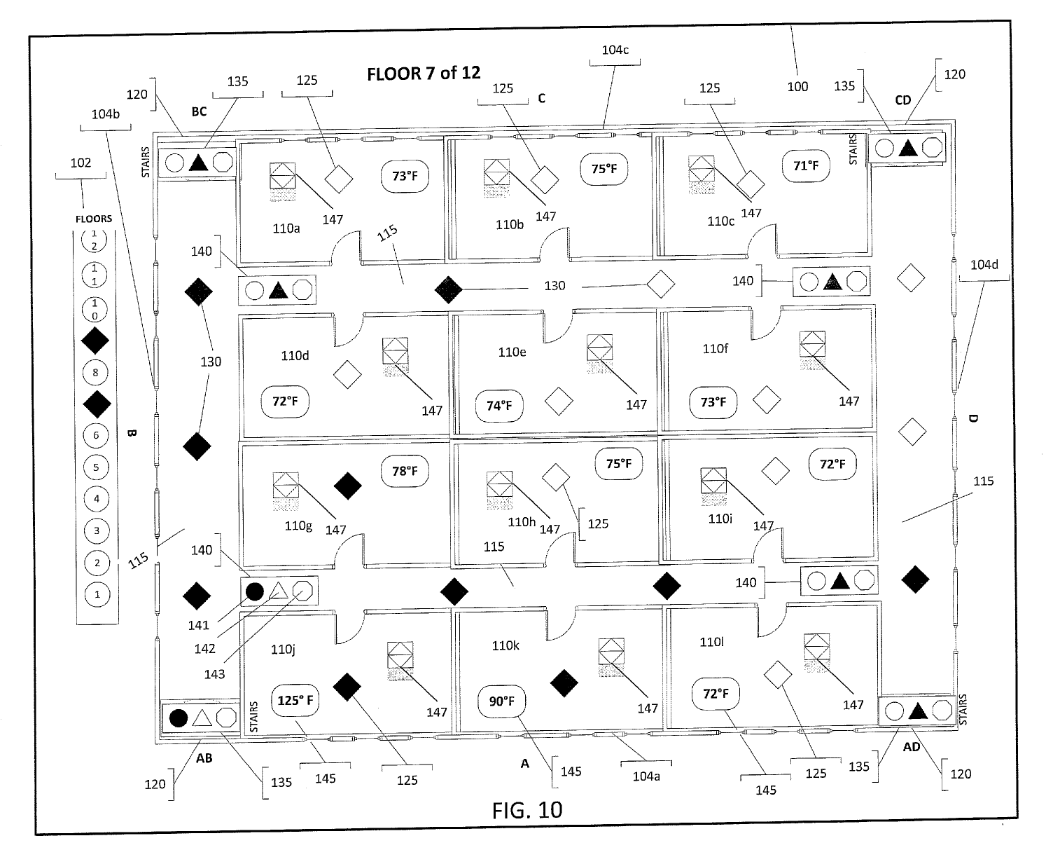

Finally, FIG. 3 demonstrates the activation and instruction of a safe evacuation route from the building 100. FIG. 3 is once again an image of the same floor 100 as shown in FIGS. 1 and 2. In FIG. 3, however, a first responder firefighter has already changed the signal arrays 135 and 140. The first responder is indicating that the stairs 120 in the BC, CD and AD corners of the building 100 are safe for exit. The hallway arrays 140 also illustrate which hallways may be safely passed through by green icon 141. However, the AB corner of the building 100 is shown as having a stop or avoid icon 142 that directs persons away from that stairway. Similarly, the end of the hallway 115 that is proximate the AB corner of the building is likewise designated as a stay-away or no-go area by an icon 142. It should also be noted on FIG. 3 that additional hallway sensors 130 and room sensors 125 have been activated. This provides information to the first responder firefighter to allow them to decide how they may approach the fire. As explained, it also allows the firefighter to define the safe exit routes for persons on the floor as well. The temperature display 145 also shows an increase in temperature in rooms 110g and 110k that communicates to a firefighter the spread of heat from the actual fire. Finally, FIG. 3 also shows in the table 102 that floor 9 has also had sensors triggered that may signal a fire event. This may be caused by any number of reasons such as smoke flow through vents and other ducts. FIG. 10 is similar to FIG. 3 but contains additional icons representing individual room signaling stations 147 in an active state. These signaling station provide both visual and audio evacuation instructions. Regardless, this is additional information that is available to a firefighter.

Exemplary embodiments can provide interactive reporting of facility fire information between four basic subsystems over an Internet/Ethernet communications link. The four subsystems are discussed as follows:

(1) Fire Alarm Panel

This subsystem directly monitors the status of individual sensors and reports their state to the requesting host, remote and mobile computer subsystems. Embedded data sets can be used to provide host, remote and mobile users detailed information on the site.

(2) Host Computer

This subsystem, through a communications interface, provides a real-time display of a regional map depicting the location of all the sites within a security network and their status. Other remote subsystems used to remotely monitor the sites can gain access to the fire alarm panel for each site through the host computer display page. A local graphic interface provides the host computer operator access to the same detailed information. Communications programs operating within the host maintain real-time status of the sites/alarm points and continually update the display screen.

(3) Remote Computer

This subsystem accesses the communication program within the host computer which displays a map of the area sites and their current status. Using a mouse, a site can be selected to view the details of its status. Upon selection, the remote subsystem can be directly connected via a hyperlink to an embedded communication program within the fire panel. Similar to the host computer, the screen updates of site and point status is maintained through a communications program.

(4) Mobile Computer

The mobile computer can gain connectivity to the ethernet network local to the fire panel through a wireless LAN, once it is within the operating range. “Broadcast packets” (for example, encrypted packets which can be decrypted by the mobile computer) can be sent by the fire panel and be used to instruct the mobile computer how to directly access the fire panel's communication interface through a monitoring station program. Once connected to the fire panel, the mobile computer interface may in some alternatives operate like the remote computer. In other alternatives, the mobile computer can only view the evolving emergency.

2. General Communications Overview

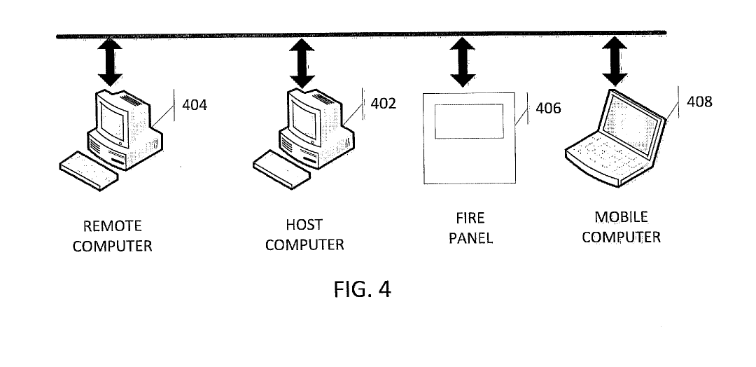

Communications between the various subsystems of embodiments of the present invention are disclosed in FIG. 4. Standard network communication tools may be combined with unique graphics and communication programs to effect real-time performance through minimal bandwidth.

FIG. 4 provides a general overview of the communications that transpire between the four basic subsystems of embodiments of the present invention; that is, (1) a host computer 402; (2) a remote computer 404; (3) fire panel 406; and (4) mobile computer 408. For example, following a powerup indication from the fire panel, and a connection by the host's local communication program to the fire panel's embedded communication program, files regarding site information (such as floor plan) and alarm status information can be sent to the host. Similar protocols can be followed with respect to communications between the remaining subsystems.

Those skilled in the art will appreciate that the information flow represented by the various communications paths illustrated in FIG. 4 are by way of example only, and that communications from any one or more of the four basic subsystems shown in FIG. 4 can be provided with respect to any other one of the four basic groups shown, in any manner desired by the user.

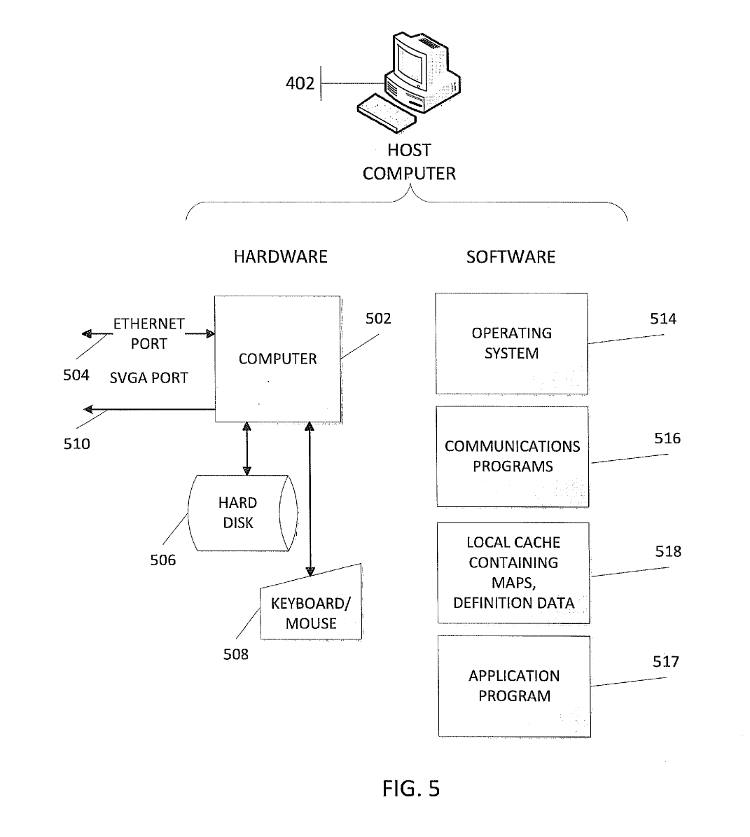

FIG. 5 depicts hardware and software components of an exemplary host computer 402. The CPU motherboard 502 for example, (e.g., based on Intel processor or any other processor) is a conventional personal computer that will support any desired network operating system 514, such as any 32-bit operating system including, but not limited to the Microsoft XP Operating System. An exemplary motherboard will feature, or accommodate, Ethernet communications port 504 for interfacing with an Internet or Ethernet network. A hard disk 506 can be installed to support information storage. A keyboard and mouse 508 can be attached for operator interface. A display, such as an SVGA monitor can be attached via an analog or digital video graphics applications port 510 for a visual display unit. The Operating System 514 can be installed in a standard manner, along with the network communication software package 516. An application program 517 is installed. A local cache directory 518 is installed with supporting graphic files (i.e. regional maps), local definition data files, and any other desired information.

b. Remote Computer

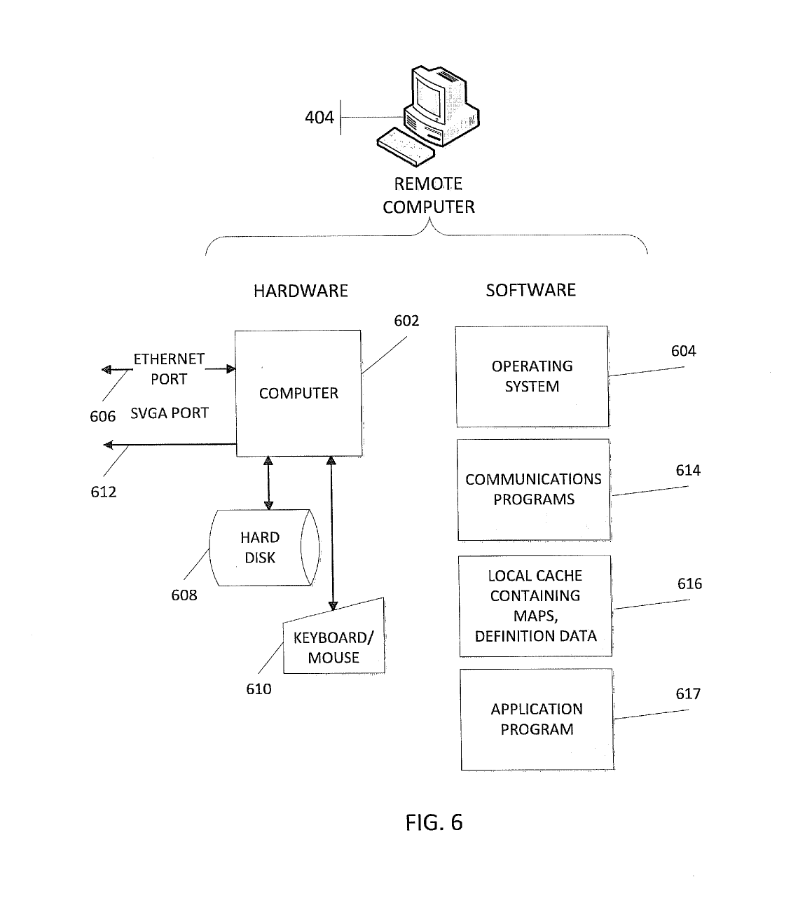

FIG. 6 depicts hardware and software components of the exemplary remote computer 404. The CPU motherboard 602 (e.g., based on Intel processor or any other processor) is a conventional personal computer that will support the desired network operating system 604, such as any 32-bit operating system, including but not limited to the Microsoft XP Operating System. The motherboard will feature, or accommodate Ethernet communications 606 with an Internet or Ethernet network via Ethernet port 606. A hard disk 608 will support information storage. A keyboard and mouse 610 will provide operator interface. An SVGA monitor can be attached via port 612 for a visual display unit. The operating system 604 is installed in a standard manner, along with a communication software package 614. An application program 617 is installed. A local cache directory 616 is installed with supporting graphic files (for example, individual room layouts, floorplans, side view of multi-story facility, and so forth), local definition data files, and other local data files.

c. Fire Alarm Panel

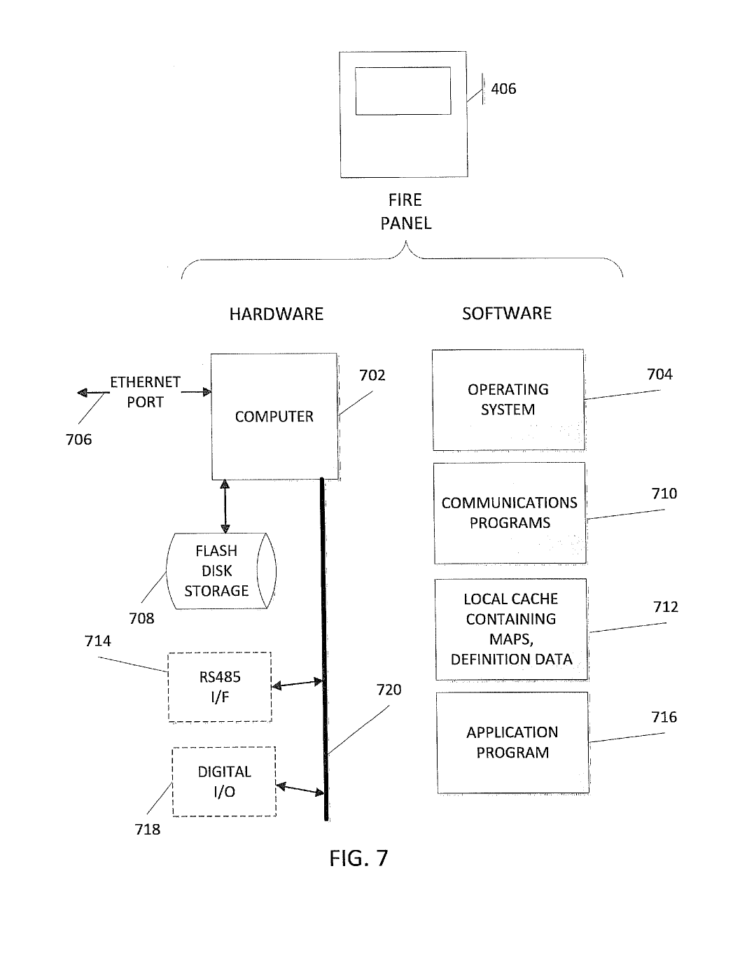

FIG. 7 depicts hardware and software components of the exemplary security/fire panel 407. The CPU motherboard 702 (e.g., based on Intel processor or any other processor) is an embedded computer that will support the desired network operating system 704 such as any embedded 32-bit operating system including, but not limited to the Microsoft embedded XP operating system. The motherboard will feature, or accommodate Ethernet communications with an Internet or Ethernet network via Ethernet port 706. A “flash” disk 708 will support information storage. The operating system can be installed in a standard manner. A communication program 710 is installed. A main application program 712 is also installed, including local data files, and the primary data repository 716 for all graphics and definition files related to the site monitored by this Panel. Communications protocols, such as RS485 communications protocols 714, are supported to facilitate communications with the sensors, sensor controller and other access devices. As supporting inputs, direct digital I/O boards 718 can be added to the local bus 720.

d. Mobile Computer

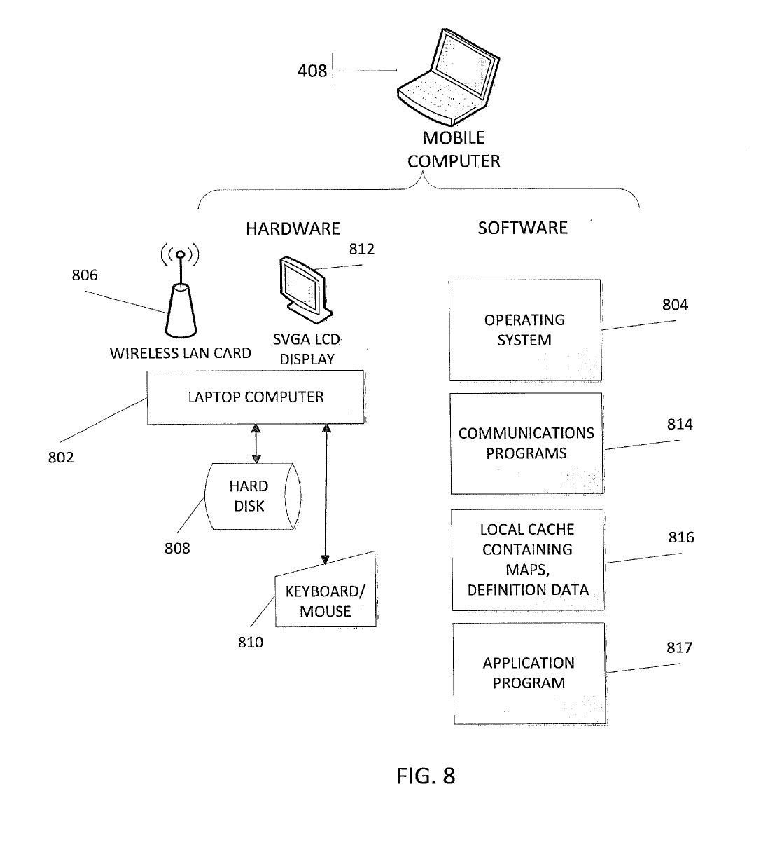

FIG. 8 depicts the hardware and software components of the exemplary mobile computer 408. The CPU motherboard 802 (e.g., based on Intel processor or any other processor) is a conventional laptop computer or other mobile computing platform that will support the desired network operating system 804, such as any 32-bit operating system including, but not limited to the Microsoft XP Operating System. Add-on boards can be installed to interoperate with, for example, IEEE 802.11 Ethernet communications 806. A hard disk 808 is installed to support information storage. An integral keyboard and mouse 810 are attached for operator interface. A display, such as an SVGA LCD monitor 812 is attached for a visual display unit. The operating system can be installed in a standard manner, along with a communications software package 814 and application software package 817. A local cache directory 816 is installed with supporting graphic files (i.e. individual room layouts, floor plans, side view of multi-story facility, and so forth), local definition data files, and other local data files.

d. Mobile Fire Panel Communications

The mobile computer may gain access to the fire panel through a wireless local area network, enabled by a wireless LAN hub and/or any available wireless network including, but not limited to existing cellular telephone networks. The mobile computer communication software is executed and seeks to connect to the fire panel's embedded communications program. When access is allowed, the remote computer requests that the embedded communication program download the definition data files that define the fire panel's display page. The definition data files include a reference to a graphics file. If the current version of the file does not locally exist, the remote computer requests the HTTP transfer of the graphics file from the fire panel. Once received from the fire panel in response, the graphics file is locally stored (in cache directory) and is displayed. Once the required data is determined to be located on the remote computer, the communications program begins a continuous polling sequence, requesting the status of the various points via a status request. When the communications program receives the response status messages, all the icons overlaying the graphics screen are repainted to indicate the current status of the points.

The signal arrays are installed proximate exit door ways. However, in the event that the exit doorways are spaced apart in any substantial length, then the display arrays may be mounted in sequential distances between the various exit doors. The signal arrays may alternatively also be mounted in each room. The signal arrays may have any number of visual signals programmed to be presented to a person in the building. The amount of information that may be conveyed is limited only by the reasonable visual surface of the array and the complexity of the signal to be communicated. Those signals may include words and/or sound instructions, for instance voice instructions. However, in the embodiment described herein, there are three different multicolored visual signals. The yellow signal indicates that a sensor has been activated. This is an informational and cautionary signal only. No evasive action is requested from the people in the building. The green signal is an instruction to proceed to the exit proximate the green signal for fast and efficient exit from a building. On the contrary, a red signal is an instruction to avoid a particular exit path. The red signal may be activated to guide persons away from the source of a fire event. Additionally, it may direct persons away from a particular path or route that will be used by emergency first responders such as fire and rescue teams. These signals are activated and are under the control of a first responder so that the first responder or professional can identify the safe evacuation route.

In still further examples, the signal arrays mounted in one or more of the stairwell, hallway or room locations may include interactive audio abilities. The signal arrays may be activated to give general audio instructions regarding a fire event and evacuation. The signal arrays may be programmed to allow a first responder to send custom audio messages. The signal arrays may also be able to be activated for direct verbal communications between a person in a room, hallway or stairwell and a first responder or other monitor of a developing situation in a building. Different protocols may be used to activate the various audio messages or audio interactions that may be appropriate or needed.

In another embodiment of the present invention, sensors are provided at various locations in the space that is to be monitored. These sensors are able to provide real-time or substantially real-time monitoring of an environmental or other parameter and provide signals indicating a value of the parameter. Each sensor is in communication with one or more fire panels, as described above. In embodiments of the present invention, the fire panel monitors the status of the various sensors, for example, by polling the sensors at regular time intervals, such as 1.5 seconds, or other intervals appropriate to the space and parameter being monitored.

In an embodiment of the present invention, the fire panel is in communication with a supervisory monitoring system at an ERC, which, as described above, can include a host computer configured with an communication program. The supervisory monitoring system is provided with a visual display to graphically represent the status of the various sensors. For example, in the case of temperature sensors, the visual display of the supervisory monitoring system may represent numerically the latest reported temperature at each of the temperature sensors. In the case of a sprinkler control valve, the visual display of the supervisory monitoring system may represent the latest state of the valve (OPEN, RECENTLY OPEN or CLOSED) at each sprinkler control valve. In addition, various alarm states, as described below, may be represented, such as by differently colored icons or by other representations as discussed below and as apparent to one of skill in the art in view of this specification.

In another embodiment of the present invention, a plurality of sensors are located at various predetermined monitoring locations of a space to be monitored. As described above, these sensors monitor an environmental or other parameter and provide signals indicating the value of the parameter to a fire panel. As the state of the sensor changes in response to changes in the value of the parameter being measured, the fire panel will provide self-initiated real-time or substantially real time notification signals to a monitoring system indicating the new state of the sensor. In an embodiment, the fire panel will only provide the real-time or substantially real-time self-initiated notification signal in the event of a change in the sensor that exceeds a predetermined value. For example, in the case of temperature sensors, the fire panel may be programmed only to provide a notification signal if the change in temperature is greater than 1 degree F. In another embodiment, the fire panel may be programmed to provide a notification signal after a predetermined period of time, or at predetermined intervals after an initial notification signal triggered by a high-end, low-end, rate-of-change or other alarm.

In such embodiments, the monitoring system is provided with a visual display that represents the space being monitored with sensor control valves. In diagrams such as floor plan diagrams, different colors or shadings of the icons may be used to represent different values of a parameter. A parameter measurement as determined by a sensor may also be displayed digitally and/or through display of different colors, shadings, and other variations of a corresponding icon.

In embodiments of the present invention, alarm information is transmitted to and displayed by a monitoring system including one or more mobile devices, such as personal computers equipped with wireless communication capabilities, used by firefighters or hazardous materials or other response personnel as they travel to the space in response to an alarm. As the sensor states change in response to parameter-value changes in the monitored space, these response personnel can receive that information in near real-time, and can develop a strategy, as they travel to the monitored space, for addressing the problem that triggered the alarm. In situations where an alarm requires responses by multiple teams—such as a large fire or chemical fire requiring fire, police, rescue and environmental teams—embodiments of the present invention provide each team with mobile monitoring capabilities displaying the same information, including changes about the alarm situation, in near real-time. An ERC may take command, for example, to manage the multiple first responder team response. These teams thus have the ability to develop a plan and coordinate their planned actions as they travel to the monitored site, thus improving the timeliness and effectiveness of their response and enhancing their own safety.

Other embodiments of the present invention will be apparent to those skilled in the art from consideration of the specification. It is intended that the specification and Figures be considered as exemplary only, with a true scope and spirit of the invention being indicated by the following claims.

What is claimed is:

1. A method for signaling specific evacuation routes from inside a building comprising the steps of:
providing a plurality of signal arrays adapted to each be able to display a plurality of different signals; a plurality of fire alarm sensors; a fire alarm panel operatively linked to the arrays and to the sensors; and wherein the fire alarm panel is further operatively linked to a firefighter computer;
installing the signal arrays and sensors in a building and linking them to a fire alarm panel, wherein the signal arrays are proximate exit doors and paths within the building;
upon activation of a sensor, sending an alarm to a firefighter;
presenting a building floor plan to the firefighter on the computer;
identifying by the firefighter an appropriate evacuation route for the building; and
instructing by the firefighter the display of signals on the arrays to visually guide persons in the building to evacuate the building.

2. The method described in claim 1, wherein the signal arrays each comprise three different colors, and each color designates a specific evacuation action.

3. The method described in claim 1, wherein the building plan presented to the firefighter comprises visual sensor points that correspond to the location of fire alarm sensors in the building.

4. The method described in claim 3, wherein the visual alarm sensor points are designated as activated or inactive.

5. The method described in claim 1, wherein the building plan presented to the firefighter comprises visual array points that correspond to the location of the signal arrays in the building.

6. The method described in claim 5, wherein the visual signal array points are designated as activated or off for each signal that may be displayed on the signal array.

7. The Method described in claim 1, further comprising the steps of:
providing a plurality of signaling stations and installing the signaling stations in a plurality of rooms in the building; and
wherein the signaling stations are operatively linked to the fire alarm panel; and
instructing by the firefighter the display of signals on signaling stations to provide visual and audio instructions to guide persons in the building to evacuate the building.

8. The method described in claim 1, wherein the firefighter computer is a mobile computer.

9. A system to enable specific evacuation routes from inside a building comprising:
a plurality of signal arrays adapted to each be able to display a plurality of different signals and also adapted to be installed proximate exit doors and paths within the building;
a plurality of fire alarm sensors adapted to be installed in the building;
a fire alarm panel operatively linked to the arrays and to the sensors;
and wherein the fire alarm panel is operatively linked to a firefighter computer;
wherein the firefighter mobile computer is adapted to present a building floor plan to the firefighter;
whereby the firefighter is able to identify and instruct the display of signals on the arrays to visually guide persons in a building to evacuate the building.

10. The system described in claim 9, wherein the signal arrays each comprise three different colors, and each color designates a specific evacuation action.

11. The system described in claim 9, wherein the building plan presented to the firefighter comprises visual sensor points that correspond to the location of fire alarm sensors in the building.

12. The system described in claim 11, wherein the visual alarm sensor points are designated as activated or inactive.

13. The system described in claim 9, wherein the firefighter computer is a mobile computer.

14. The system described in claim 9, wherein the building plan presented to the firefighter comprises visual array points that correspond to the location of the signal arrays in the building.

15. The system described in claim 14, wherein the visual signal array points are designated as activated or off for each signal that may be displayed on the signal array.
